(19) United States
(12) Patent Application Publication
(10) Pub. No.: US 2010/0296982 A1
(43) Pub. Date: Nov. 25, 2010

(54) CRYSTALLIZATION REACTION APPARATUS FOR PREPARATION OF MASSIVE CRYSTALLINE PARTICLES AND CRYSTALLINE SEPARATION PROCESSING SYSTEM

(75) Inventors: Jongpal Hong, Seoul (KR); Hyeryeon Kang, Seoul (KR); Dayoung Kim, Seoul (KR); Changhoon Lee, Seoul (KR); Woosik Kim, Seoul (KR)

Correspondence Address: LOWE HAUPTMAN HAM & BERNER, LLP, 1700 DIAGONAL ROAD, SUITE 300, ALEXANDRIA, VA, 22314, US

(73) Assignee: KNDT&I CO., LTD, Seoul (KR)

(21) Appl. No.: 12/812,832

(22) PCT Filed: Jun. 10, 2008
(86) PCT No.: PCT/KR08/03227

§ 371 Date: Jul. 14, 2010

(51) Int. Cl. B01J 19/18

(52) U.S. Cl. 422/187; 422/225

(57) ABSTRACT

Disclosed is a crystallizer comprising: a reaction bath having an inlet for feeding a reactant, an outlet for discharging a reaction product, and an inner reaction space in which a crystallization reaction is proceeded; and an agitation bar placed in the inner reaction space of the reaction bath, one cross-section of which is smaller than the other cross-section of the bar in a direction of flowing the reactant.

### TECHNICAL FIELD

The present invention relates to a crystallization reaction apparatus, and more particularly, to a crystallizer with performance for preventing breaking of crystals caused by overgrowth thereof during crystallization so as to accomplish growth of massive crystalline particles, as well as a crystal separation processing system including the crystallization reaction apparatus.

### BACKGROUND ART

It is generally known that a crystallization reaction is adopted to isolate a specific material in a pure state or to obtain a crystalline particle with controlled shape or size. Conventional discontinuous type crystallizers widely used in the prior art have difficulty in ensuring uniform mixing of at least one reactant to be crystallized, causing a problem in formation of crystalline particles with a constant size and/or shape.

In order to solve the above problem, the present inventors have proposed a continuous type reactor as shown in FIGS. 1 and 2. The continuous type reactor comprises a reaction bath 11, an agitation bar 12, an inlet 13 for feeding the reactant, an outlet 14 for discharging a reaction product, that is, crystals, and optionally another inlet 15 for feeding seeds or other additives, a heating part 16 for supplying heat to the reaction bath, and an inner reaction space 17 in which a crystallization reaction is proceeded. Such a reactor generates a taylor vortex in a reaction flow by rotation of an agitation bar which in turn uniformly mixes the flow, thereby producing crystals with a regular particle size.

In many cases of crystallization, a process for preparing a crystal is performed in two steps including a first crystallization step to form a nucleus (also referred to as nucleation) and a second crystallization step to grow the formed nucleus. However, since a great amount of reactant initially injected into the reactor mainly undergoes the first crystallization step, the formed nuclei (that is, crystals) cannot be massively grown. Therefore, owing to relatively small crystalline particles, it is difficult to isolate and purify the crystals in a further process for separation of crystals.

### DISCLOSURE OF INVENTION

### Technical Problem

in regard to conventional methods and an object of the present invention is to provide a crystallizer for production of massive crystalline particles wherein breaking of crystals in a reaction space caused by overgrowth thereof during crystallization is prevented.

Another object of the present invention is to provide a crystal separation processing system including the crystallizer described above, wherein breaking of crystals in a reaction space caused by overgrowth thereof during crystallization is prevented so as to accomplish production of massive crystalline particles.

### Technical Solution

In order to accomplish the above objects, the present invention provides:
(1) a crystallizer comprising: a reaction bath having an inlet for feeding a raw material (that is, a reactant), an outlet for discharging a reaction product, and an inner reaction space in which a crystallization reaction is proceeded; and an agitation bar placed in the inner reaction space of the reaction bath, one cross-section of which is smaller than the other cross-section of the bar in a direction of flowing the reactant, and
(2) a crystal separation processing system comprising: a reactant feeding unit; the above crystallizer to receive the reactant provided from the feeding unit; and a solid-liquid separator for isolating crystals from a solution discharged from the above reactor.

### ADVANTAGEOUS EFFECTS

According to a technical construction of the present invention described above, overgrowth of crystalline particles during crystallization and breaking of the grown crystals thereby may be prevented so as to accomplish production of massive crystalline particles. Therefore, the present invention may effectively and easily isolate crystals in a solid-liquid separation process.

### BRIEF DESCRIPTION OF DRAWINGS

The above objects, features and advantages of the present invention will become more apparent to those skilled in the related art in conjunction with the accompanying drawings. In the drawings:

FIG. 1 is a cross-sectional view illustrating a technical construction of a conventional crystallizer;

FIG. 2 is a perspective view illustrating a taylor vortex generated in the conventional crystallizer;

FIGS. 3 to 6 are cross-sectional views illustrating technical constructions of crystallizers according to first to fourth embodiments of the present invention, respectively; and

FIG. 7 is a schematic view illustrating a technical construction of a crystal separation processing system according to the present invention.

### DESCRIPTION OF SYMBOLS FOR MAJOR PARTS IN DRAWINGS

11, 21, 31: reaction bath
12, 22, 33: agitation bar
13, 23, 33: reactant inlet
14, 24, 34: reaction product outlet
15, 25, 35: additive inlet
16, 26, 36: warming jacket
17, 27, 37: inner reaction space
41: agitator
42: seed containing solution
43: reactant containing solution
44: pump
45: crystallizer
46: solid-liquid separator
47: pH meter
48: electron microscope
49: fineness analyzer

### MODE FOR THE INVENTION

The present invention will be more apparent from the following detailed description with accompanying drawings.

According to the present invention, there is provided a crystallizer comprising: a reaction bath having an inlet for feeding a reactant, an outlet for discharging a reaction product, and an inner reaction space in which a crystallization reaction is proceeded; and an agitation bar rotatably placed in the inner reaction space of the reaction bath, one cross-section of which is smaller than the other cross-section of the bar in a direction of flowing the reactant.

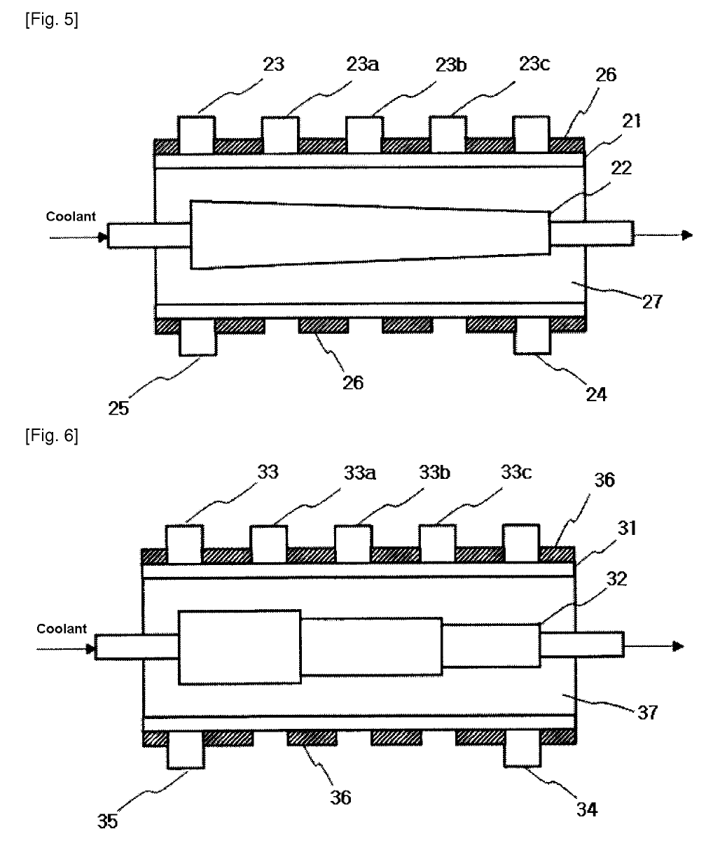

FIG. 3 is a cross-sectional view illustrating a technical construction of a reactor according to the present invention. The reactor comprises a reaction bath 21, an agitation bar 22 placed in the reaction bath, at least one inlet 23, 23a, 23b and/or 23c for feeding the reactant, an outlet 24 for discharging a reaction product, that is, crystals, and optionally another inlet 25 for feeding seeds or other additives and a heating part 26 for supplying heat to the reaction bath. Moreover, numerical number 27 represents an inner reaction space of the reaction bath. The reactor is particularly suitable for crystallization reaction.

The reaction bath 21 is substantially formed in a round cylindrical shape and the inlets 23 and 23a to 23c for feeding the reactant are disposed in series at the uppermost end of the reaction bath. Such multiple inlets for feeding the reactant allow the reactant to be injected at the same time or divisionally injected at a predetermined interval to the reactor. That is, a predetermined amount of reactant is first injected to the reaction bath to form crystal nuclei and a fresh reactant is additionally injected in a predetermined fraction to the reaction bath in which the crystal nuclei already formed is combined with the later injected reactant so as to grow the crystal nuclei. The grown crystals are additionally combined with a fresh reactant further injected in a predetermined fraction thereinto, and therefore, are more enlarged in size. Accordingly, the above process may produce massive crystalline particles.

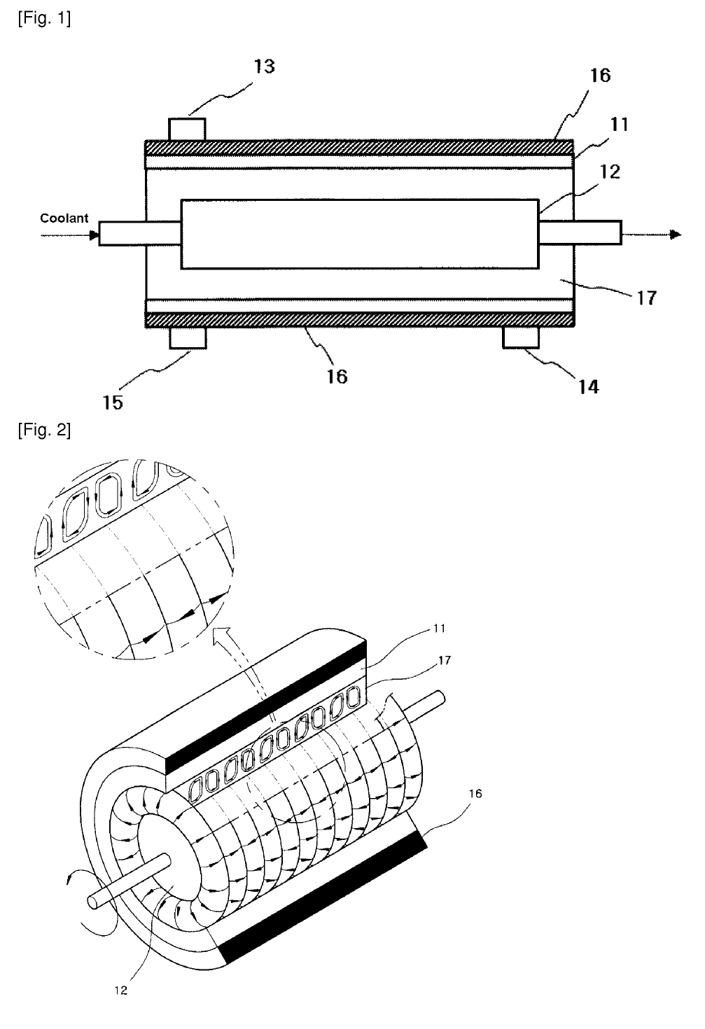

As shown in FIG. 1, if a reactant is injected into only an inlet 13 for feeding in the reactant to proceed crystallization, the injected reactant is mostly used in growing crystal nuclei, thus restricting production of massive crystals. Consequently, the above process produces a crystalline particle with reduced size which in turn causes a difficulty in separation of crystals from the solution.

Other inlets 23a to 23c for feeding excess reactant have a role of not only divisionally introducing the reactant at intervals but also feeding seeds for crystallization and/or different additives thereto.

Furthermore, the inlets 23a to 23c for feeding excess reactant may also be provided for introducing a device to determine reaction conditions (for example, pressure, flow rate, pH, temperature, etc.) so as to control these conditions.

A shape of the agitation bar 22 is not particularly limited but may include a round cylindrical shape to homogeneously blend the reactant, thereby uniformly controlling temperature of the reactant. The agitation bar 22 may have an inner space or not. In general, the agitation bar having the inner space may include a heat transfer medium to control temperature of the reactant.

The agitation bar 22 may rotate around a center axis of the reaction bath 21. For this purpose, the agitation bar 22 may be connected to an external rotation motor at one end thereof. Instead of a self-rotational agitation bar, rotating the reaction bath may also exhibit the same effect.

If a rotation rate of the agitation bar 22 is more than a critical point, a fluid around the agitation bar receives a centrifugal force in a vertical direction from a rotational axis to move, thus generating a taylor vortex. This results in a highly homogeneous flow and a very uniform distribution of temperature and, in addition, a regular crystalline particle size is obtained.

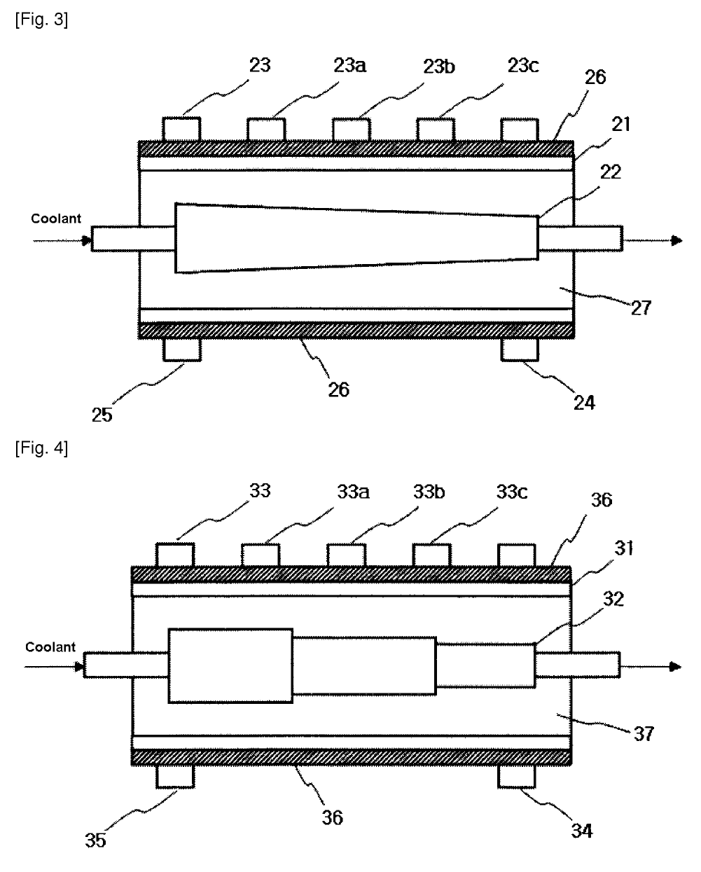

A process for generating a taylor vortex in a solution based on a rotational movement of the agitation bar 22 is substantially the same as illustrated in FIG. 2. A flow in the reaction bath 21 may be characterized by multiple vortex cells periodically aligned around an axis of the agitation bar 22. For instance, in a case where a fluid flows in a space between the agitation bar 22 and the reaction bath 21, a centrifugal force is generated by rotation of the agitation bar 22 and the fluid around the agitation bar tends to move toward the fixed reaction bath. As a result, a fluid layer becomes unstable to generate the taylor vortex. A taylor vortex region is present when the rotation rate of the agitation bar 22 is more than a critical point. Each of flow elements includes a pair of ring type vortexes rotating in opposite directions to each other.

As described above, the present inventive reactor utilizes a taylor vortex so that a remarkably regular and homogeneous mixing process is performed and a temperature distribution is uniform throughout the reactor, resulting in crystals with a considerably regular and uniform particle size.

Divisional introduction of the reactant may greatly grow crystals in a flow direction of a reactive solution, as described above, so that the final massive crystalline particles are effectively produced. In this regard, if the agitation bar 22 is formed in a cylindrical shape having a uniform cross-sectional diameter, the agitation bar may restrict growth of the massive crystalline particles. The reason behind this fact is that a final size of the crystalline particle depends on a space between the agitation bar 22 and an outer reaction bath 21. Since the crystalline particle size should not exceed the space, the grown crystal breaks by friction with the reaction bath due to rotation of the agitation bar. Such breaking may cause a decrease in separation efficiency when the crystalline particles are isolated from the reactive solution in a further solid-liquid separation process.

Accordingly, as the agitation bar 22 has a gradually decreased diameter in a direction of flowing the reactive solution, it is possible to prevent a crystalline particle from being broken.

More particularly, the agitation bar 22 is formed with a tapered shape wherein a diameter of the agitation bar is gradually reduced in a direction in which the reaction proceeds (FIG. 3), or may be formed in a multi-staged cylindrical shape including multiple cylinders with small diameters connected together in series (FIG. 4).

Herein, one cross-section of the agitation bar has a diameter different from that of the other cross-section and a diameter ratio between both the cross-sections may range from 0.01 to 1.5, preferably, 0.1 to 1.0. Such a ratio may be determined in consideration of various reactants and/or reaction conditions so far as these reactants and/or reaction conditions do not affect formation of a taylor vortex. In this regard, if the diameter ratio is too large, the formation of a taylor vortex may become very difficult although not impossible. On the other hand, if the diameter ratio is too small, such an agitation bar may not support growth of crystalline particles or the crystalline particles may not be sufficiently grown.

In an inner reaction space 27 or 37 between the agitation bar 22 or 32 and the reaction bath 21 or 31, crystallization is performed by the reactant. Raw materials used in the crystallization may include any substances commonly known to be used in a number of crystallization reactions. A predetermined amount of such reactant is injected into inlets 23 and 23a to 23c or 33 and 33a to 33c for feeding in the reactant, respectively, which are provided at one side of the reaction bath 22 or 32. After that, the reactant may be further divisionally injected at a predetermined interval to the reaction bath. FIGS. 3 and 4 illustrate the maximum number of the reactant inlets to be five. However, this is given for illustrative purposes only and an interval between at least two inlets and/or the number of the inlets are of course desirably selected by those skilled in the art.

Particular examples of raw materials, that is, the reactant, may include various amino acids (for example, amino acid such as tryptophane, lysine, alanine, methionine, phenylalanine, leucine, isoleucine, glycine, valine, arginine, arginate, glutamine, glutamate, serine, threonine, etc. or derivatives thereof), nucleic acid (guanosine monophosphate, cytosine monophosphate, adenosine monophosphate, tymine monophosphate, etc. or derivatives thereof), protein (including oligopeptide, polypeptide, etc.), organic compounds such as benzoic acid, p-xylene, chlorobenzene, etc., as well as inorganic metal salts such as copper sulfate, sodium chloride, sodium acetate, potassium chromate, sodium sulfate, calcium acetate, sodium chromate, barium acetate, etc. Consequently, the present invention may use any materials capable of extracting crystals in an supersaturated state under desired conditions as the reactant.

The reactant entered through the inlets 23 and 23a to 23c or 33 and 33a to 33c flows in the form of solution or molten liquid through the inner reaction space 27 or 37 of the reaction bath and may remain in the reaction bath for a residence time for crystallization.

Such crystallization reaction performed using the reactor according to the present invention is not particularly restricted but may include all types of crystallizations, for example, reactive crystallization, salting-out crystallization, drowning-out crystallization, cooling crystallization, evaporative crystallization, and the like.

In case of the reaction involving cooling crystallization, the crystallization may be controlled by a refrigerant contained or flowing in the agitation bar 22 or 32. The coolant absorbs heat from a raw material in a solution state to become supersaturated. As a result, crystallization is started on a surface of the agitation bar 22 or 32 and is extended in a vertical direction to a rotational axis.

Temperature inside the reaction bath 21 or 31 via heat exchange may be controlled to a desired level in relation to thermo-dynamic equilibrium. That is, if physical information including, for example, thermal capacity of a solution contained in the reaction bath 21 or 31, thermal capacity of a medium flowing in the agitation bar 22 or 32, etc. is known, an internal temperature of the reaction bath 21 or 31 may be suitably controlled to a desired level. Herein, temperature control may be performed by adjusting an amount of heat provided from a heat supply unit 26 or 36 which is installed in the reaction bath 21 or 31. Preferably, the heat supply unit 26 or 36 may be embodied in the form of a warming jacket.

FIGS. 5 and 6 illustrate a warming jacket 26 or 36 mounted on an outer side of the reaction bath in the crystallizer according to the present invention.

The heat supply unit 26 or 36 may be partially or entirely mounted on the reactor and may be partitioned into sections in which multiple inlets for feeding the reactant are positioned, wherein the temperature control may be performed for each of the sections.

Other than the coolant as the heat transfer medium, the present invention may optionally use a high temperature medium such as hot water. The high temperature medium depends on characteristics of the reaction performed in the reactor and may be preferably selected by those skilled in the art. In case of using the coolant described above, the coolant is not particularly limited but may include, for example, water, ethylene glycol, etc. Selection of a specific solvent depends on type of reactions. For instance, if it is required to cool below 0° C., water being solidified (that is, frozen) is difficult to use while ethylene glycol is preferably used.

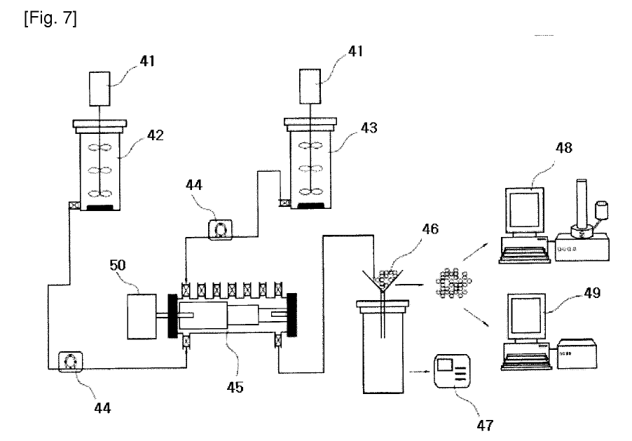

FIG. 7 shows a crystal separation processing system including the crystallizer according to the present invention.

A reactant 43 to be crystallized becomes homogenous by an agitator 41 and then is fed into a reactor 45 through a liquid pump 44. If necessary, an additional material 42 as a seed for crystallization is uniformly treated by the agitator 41 and may also enter into the reactor 45 through the liquid pump 44.

In the reactor 45, rotating the agitation bar as described above may generate a taylor vortex in the reactant so as to make the reactant to be homogeneously mixed. Moreover, divisional introduction may further accelerate growth of crystals with progress of the reaction and thus a solution containing completely grown crystals may be discharged from an outlet.

The discharged solution is separated into a liquid part containing impurities and pure crystals by a solid-liquid separator 46.

The isolated crystals are collected out of the outlet and delivered to the solid-liquid separator 46, thus preparing a crystalline material with a high purity.

The pure crystalline material obtained above is subjected to measurement of H+ ion concentration using a pH meter 47. More particularly, the crystalline material in a solid or liquid state, which was isolated by the solid-liquid separator 46, is attached on an object plate using a conductive carbon tape and observed by an electron microscope 48 for size analysis of respective crystalline particles.

The crystalline material in the solid or liquid state isolated by the solid-liquid separator may also undergo measurement of fineness by a sonication type fineness analyzer 49. The produced crystal is a coagulated material of small crystals combined together by physically weak attraction. The produced crystals are subjected to fineness analysis at an interval of 1 minute. From results observed from the analysis, wherein the fineness is not changed after a predetermined time period and/or the small crystals strongly combined together form a coagulated crystal substantially not degraded by sonication, a size of the coagulated crystal may be determined.

While the present invention has been described with reference to the accompanying drawings and exemplary embodiments, it will be understood by those skilled in the art that various modifications and variations may be made therein without departing from the scope of the present invention as defined by the appended claims.

### INDUSTRIAL APPLICABILITY

According to the technical construction of the present invention disclosed above, the present invention effectively prevents a crystal from being broken in a reaction space due to overgrowth thereof during crystallization so that massive crystalline particles may be produced, thereby being preferably used in industrial applications.

Although the present invention has been described in connection with the exemplary embodiments illustrated in the drawings, it is only illustrative. It will be understood by those skilled in the art that various modifications and equivalents can be made to the present invention. Therefore, the true technical scope of the present invention should be defined by the appended claims.

1. A crystallizer comprising:
a reaction bath having an inlet for feeding a reactant, an outlet for discharging a reaction product, and an inner reaction space in which a crystallization reaction is proceeded; and
an agitation bar placed in the inner reaction space of the reaction bath, one cross-section of which is smaller than the other cross-section of the bar in a direction of flowing the reactant.

2. The reactor according to claim 1, wherein the agitation bar rotates in the reaction bath to generate a taylor vortex in a reactive solution.

3. The reactor according to claim 1, wherein a plurality of the reactant inlets are disposed at a predetermined interval in a longitudinal direction of the reaction bath.

4. The reactor according to claim 1, wherein the agitation bar is formed with a tapered shape.

5. The reactor according to claim 1, wherein at least two agitation bars are formed in cylindrical shapes having different diameters and are connected together in multiple stages.

6. The reactor according to claim 1, wherein a ratio of diameters between one cross-section and the other cross-section of the agitation bar ranges from 0.01 to 1.5.

7. The reactor according to claim 1, wherein a ratio of diameters between one cross-section and the other cross-section of the agitation bar ranges from 0.1 to 1.0.

8. The reactor according to claim 1, wherein the agitation bar is connected to an external rotation motor.

9. A crystal separation processing system comprising:
a reactant feeding unit;
a crystallizer as defined in claim 1 to receive the reactant provided from the reactant feeding unit; and
a solid-liquid separator for isolating crystals from a solution discharged from the above reactor.

10. A crystal separation processing system comprising:
a reactant feeding unit;
a crystallizer as defined in claim 2 to receive the reactant provided from the reactant feeding unit; and
a solid-liquid separator for isolating crystals from a solution discharged from the above reactor.

11. A crystal separation processing system comprising:
a reactant feeding unit;
a crystallizer as defined in claim 3 to receive the reactant provided from the reactant feeding unit; and
a solid-liquid separator for isolating crystals from a solution discharged from the above reactor.

12. A crystal separation processing system comprising:
a reactant feeding unit;
a crystallizer as defined in claim 4 to receive the reactant provided from the reactant feeding unit; and
a solid-liquid separator for isolating crystals from a solution discharged from the above reactor.

13. A crystal separation processing system comprising:
a reactant feeding unit;
a crystallizer as defined in claim 5 to receive the reactant provided from the reactant feeding unit; and
a solid-liquid separator for isolating crystals from a solution discharged from the above reactor.

14. A crystal separation processing system comprising:
a reactant feeding unit;
a crystallizer as defined in claim 6 to receive the reactant provided from the reactant feeding unit; and
a solid-liquid separator for isolating crystals from a solution discharged from the above reactor.

15. A crystal separation processing system comprising:
a reactant feeding unit;
a crystallizer as defined in claim 7 to receive the reactant provided from the reactant feeding unit; and
a solid-liquid separator for isolating crystals from a solution discharged from the above reactor.

16. A crystal separation processing system comprising:
a reactant feeding unit;
a crystallizer as defined in claim 8 to receive the reactant provided from the reactant feeding unit; and
a solid-liquid separator for isolating crystals from a solution discharged from the above reactor.
